(19) United States
(12) Patent Application Publication
(10) Pub. No.: US 2008/0252444 A1
(43) Pub. Date: Oct. 16, 2008

(54) PORTABLE IMPACT DETECTION, WIRELESS TRACKING AND DISPATCH

(75) Inventors: Fronz F. Batot, Austin, TX (US); Kenneth A. Brink, Highlands Ranch, CO (US); Randy S. Johnson, Ofallon, MO (US); Tedrick N. Northway, Wood River, IL (US); Paul D. Peterson, Round Rock, TX (US); Howard N. Smallowitz, Austin, TX (US)

Correspondence Address: IBM CORPORATION, IPLAW SHCB/40-3, 1701 NORTH STREET, ENDICOTT, NY, 13760, US

(73) Assignee: International Business Machines Corporation, Armonk, NY (US)

(21) Appl. No.: 11/734,413

(22) Filed: Apr. 12, 2007

(51) Int. Cl. H04Q 7/00

(52) U.S. Cl. 340/539.13

(57) ABSTRACT

A portable communication device/system for use with a vehicle includes a monitoring device having a motion sensor and a proximity sensor. The monitoring device initiates a signal upon the occurrence of a vehicular event such as the breaching of the perimeter specified by the proximity sensor or an abrupt motion detected by the motion sensor. A transmitting device transmits the signal to a remote receiving device to communicate the vehicular event to, for example, emergency personnel.

### FIELD OF THE INVENTION

The present invention relates to a portable communication device/system for use with a vehicle, and more specifically, relates to a portable communication device including a monitoring device and a communication device for initiating communication upon the occurrence of a vehicular event.

### BACKGROUND OF THE INVENTION

Automobile accidents of varying degrees of severity are commonplace. Fatal automobile accidents are one of the nations leading causes of death and injury. It is estimated that over six million cars in the United States are involved in accidents each year. In a serious accident a delay in receiving medical attention could mean the difference between life and death. In less serious accidents, delays in receiving medical attention could exacerbate medical conditions, and extend a patient's recovery time. Further, delays in notifying emergency personnel of an accident can cause serious traffic delays and potential dangerous situations on the roadway from disabled vehicles. Also, traffic delays caused by disabled vehicles or delays in emergency personnel can result in lost productivity of workers and businesses as travelers are delayed by the accident. Moreover, if the vehicle is carrying a toxic substance, spillable substance, or dangerous load a delay in notifying emergency person could exacerbate a serious condition or lead to other potentially fatal accidents.

Current global positioning satellite (GPS) devices can provide a means for determining where a person or vehicle is located. It is also known for some car manufactures to offer a device (e.g., using radar) which alerts the driver in fog or conditions of diminished visibility that there is an obstacle ahead by sounding an alert. One known device provides an automatic dispatch call to a call center at the time of impact in a vehicular accident, and the call center will attempt to contact the vehicle to determine support requirements. Other systems include a radio like broadcasting system on a major highway which may override normal radio transmissions to provide the driver with current congestion and accident conditions that affect travel. Another device includes obstacle detection and image displays that can be used to warn the driver of an impending impact. Also known are collision-avoidance and obstacle detection systems which have recording features.

However, the current systems and methods for initiating assistance after an accident or for avoiding an accident have drawbacks. Typically, GPS devices are limited in their use for providing mapping data, or determining the location of the users device. Known GPS devices may interface with cell phones to provide voice-prompted, turn-by-turn directions, but not to provide an automatic accident report. Further, radar detection devices are typically built into a vehicle and thus are non-portable, and are also limited to reporting or sounding an alarm when the vehicle approaches an obstacle. Cellular devices, similar to the GPS devices, permit identifying where the device is when requested to perform the tracking service, but not automatically at the time of an event. Other communication devices are activated by the deployment of the airbags, however the devices are not portable. Other devices may send information to a motorist when the motorist is in the vicinity of the transmission. However, the information sent only provides traffic and accident data in the vicinity of the transmission device, and may not be up to date with conditions at the site of an event. Other devices in trucks offer sensor features which will warn a driver of impending contact when, for example, the truck is backing up. However, these devices are not portable and do not perform dispatching or sending of event data.

A need exists to proactively assist in aiding drivers and passengers who are involved in accidents. A delay could exacerbate a serious situation and could potentially make the difference between life and death. It would also be desirable to proactively assist a driver or passenger in less serious or dramatic situations to minimize the time in notifying emergency response resources. This can result in the injured receiving prompt medical attention, and minimizing the negative affects on traffic on the roadway. In addition, there is a need for a method of rapid accident notification which includes objective data available to aid emergency personnel, and for supporting post incident investigations by law enforcement and insurance companies. It would also be desirable to provide a device for assisting drivers which is portable so that it can be easily transferred between vehicles.

### SUMMARY OF THE INVENTION

In an aspect of the invention, a portable communication device for use with a vehicle includes a housing defining an inside cavity and a monitoring device housed in the inside cavity of the portable communication device for initiating a signal upon the occurrence of a vehicular event. A transmitting device is housed in the inside cavity for transmitting the signal to a remote receiving device to communicate the vehicular event.

In a related aspect, the vehicular event includes an impact to the vehicle.

In a related aspect, an image recording device records the vehicular event.

In a related aspect, the vehicular event includes an impact to the vehicle, and the device further includes an image recording device which records the event before impact and after impact.

In a related aspect, the monitoring device includes a proximity sensor mounted inside the communication device to monitor the proximate surrounding of the vehicle, sense impending contact between the vehicle and an object, and initiate an alarm to the driver and initiate a image recording device when the proximity sensor detects the impending contact.

In a related aspect, the monitoring device includes a proximity sensor mounted in the inside cavity of the housing to monitor the proximate surrounding of the vehicle, sense impending contact between the vehicle and an object, and initiate an alarm to the driver and initiate an image recording device when the proximity sensor detects the impending contact. The image recording device records the impending contact, contact, and post contact for a specified period of time and automatically sends the recording to a remote location.

In a related aspect, the device further includes a transceiver for receiving a signal from the monitoring device and transmitting a signal to a receiving device to alert the driver.

In a related aspect, the device further includes a transceiver for receiving a signal from the monitoring device and transmitting a signal to a first receiving device to alert the driver and/or a second receiving device to alert response personnel.

In a related aspect, the housing is mounted to a vehicle.

In another aspect, a portable communication system used with a vehicle comprises a portable communication device defining an inside cavity, and a monitoring device being housed in the inside cavity of the portable communication device for initiating a signal upon the occurrence of a vehicular event. A transmitting device is housed in the inside cavity for transmitting the signal, and a remote receiving device receives the signal to communicate the vehicular event to a driver.

In a related aspect, the signal is a first signal and the remote receiving device is a first remote receiving device and the system further includes a second signal transmitted by the transmitting device and a second remote receiving device for communicating the vehicular event to response personnel.

In another aspect, a method of communicating a vehicular event comprises monitoring a vehicle for a specified vehicular event; initiating a signal upon the occurrence of the specified event; and receiving the signal at a remote location to communicate the vehicular event to a response unit.

### BRIEF DESCRIPTION OF THE DRAWINGS

These and other objects, features and advantages of the present invention will become apparent from the following detailed description of illustrative embodiments thereof, which is to be read in connection with the accompanying drawings, in which:

FIG. 1 is a perspective view of a communication device including transparent lens protectors for at least one camera inside the device and a receiving device according to the present invention;

FIG. 2 is a front elevational view of inside the device of FIG. 1 depicting a camera, motion sensor, proximity sensor, processor, and transceiver;

FIG. 3 is a front elevational view of a vehicle including the communication device shown in FIG. 1, on the vehicle's roof;

FIG. 4 is a plan view of the vehicle and communication device shown in FIG. 3; and

FIG. 5 is a flow chart of a method according to the present invention using the communication device and system.

### DETAILED DESCRIPTION OF THE INVENTION

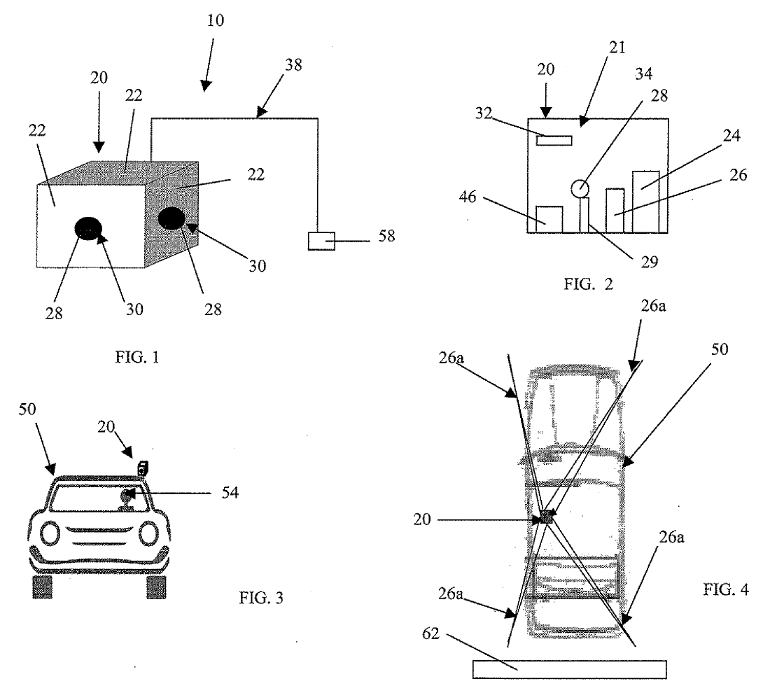

Referring to FIG. 1, an exemplary embodiment of a portable communication system 10 includes a portable communication device 20 having a housing 22 and an inside 21 (shown in FIG. 2). The communication device 20 is portable and automatically detects a vehicular event and dispatches a communication using a transmitting device embodied as transceiver 32 (in FIG. 2) to the user and/or emergency personnel or any kind of response personnel having a remote receiving device 58. Referring to FIGS. 1 and 2, the device 20 includes a monitoring device embodied as motion sensors 24 and proximity sensors 26 (only one of each is shown in FIG. 2 for illustrative purposes) in the inside 21 of the device 20. An image recording device embodied as a 360 degree camera 28 (only one shown for exemplary purposes in FIG. 2) is mounted in the device 20 using a mounting pedestal 29. The 360 degree camera 28 records the surrounding environment of the vehicle through a transparent lens protector 30 through the side wall 22 of the device 20. The 360 degree camera 28 is able to record and provide panoramic pictures below a horizontal plane with respect to the camera 28. Using software, the microprocessor 46 processes the 360 degree images to provide the panoramic pictures. Use of the 360 degree cameras enables two such cameras 28 on opposite sides of the device 20 to photograph substantially the entire surrounding area of the vehicle 50. Alternatively, more than two cameras may be mounted to record through transparent lens protectors 30, shown on two sides 22 of the rectangular shaped device 20 (FIG. 1), however, it is understood that the other two sides of the rectangular shaped device 20 have similar cameras 28 recording through transparent lens protectors 30. In a further embodiment a 360 degree camera (not shown) may be positioned (e.g., protruding slightly from the top wall 22 of the device 20) to photograph from the top of the device 20 such that the camera angle captures photographs below the horizon with respect to the camera. Moreover, a camera may include an infrared support feature to be effective at photographing at night. In another embodiment, a digital video camera may be used to create images of the area surrounding area the vehicle 50.

The proximity sensor 26 (shown in FIG. 2) monitors the surrounding area of the vehicle for an impending event, for example, an obstacle while backing up, or an approaching obstacle, such as another vehicle. The device 20 further includes a processor 46 communicating with the motion sensor 24 and the proximity sensor 26 to activate the camera 28 when the proximity sensor 26 senses an impending impact and/or when the motion sensor 24 senses an abrupt motion change, as described in more detail below. The processor 46 initiates communication of a signal 38 via a transceiver device to a receiving device 58, shown in FIG. 1, which is representative of, for example, multiple remote devices in different locations, and the remote devices may be contacted simultaneously or in series.

For example, the driver's 54 cell phone (not shown), the vehicle sound system, e.g., the radio, and/or a more distant receiving device may be contacted simultaneously or in sequence to contact or alert the driver and emergency personnel. The communication is initiated using a transmitting device, for example, a transceiver 32 which communicates with the cell phone and vehicle sound system to alert the driver. The transceiver 32 can also initiate a call to emergency personnel using the driver's cell phone to a receiving device 58 to alert emergency personnel of a vehicular event such as an accident. The transceiver 32 may use, for example, Bluetooth® wireless technology, wireless Ethernet, or other wireless technology to communicate with a, for example, Bluetooth® transceiver in the driver's 54 cell phone (not shown), and alternatively, the transceiver 32 may be wired to the cell phone. Power to the device may be supplied, for example, using the cigarette lighter of the vehicle or from an internal battery pack (e.g., vehicle battery, or a battery within the device 20).

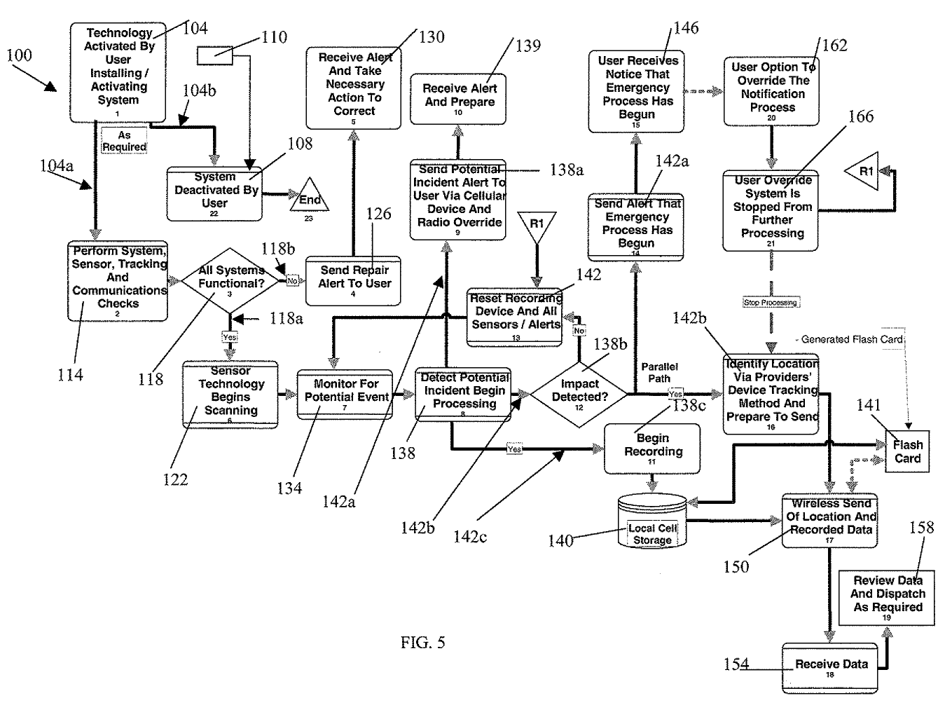

More specifically, the device 20 can be installed or removed as required, for example, on a car roof, as shown in FIG. 3, using a mounting device (not shown) similar, for example, as mounting a flag or the like. The processor 46 processes a signal from the motion sensor 24, e.g., in response to an abrupt motion indicating a vehicular incident such as an accident, and processes the information from the proximity sensor 26, such as the vehicles impending contact with another vehicle or object, represented as block 62 in FIG. 4, and initiates the camera 28 recording and the transmission of signal 38. The motion sensor 24 may continuously monitor movement of the vehicle when the device is turned on. The motion sensor 24 may be, for example, similar to those sensors used in vehicle airbag technology that are capable of detecting sudden changes in motion.

In operation, the portable communication system 10 is mounted on the roof of the vehicle and powered via the cigarette lighter in the vehicle or an internal power source, such as an internal battery pack or vehicle battery. Alternatively, the device 20 may be internally mounted within the vehicle. The processor activates the proximity sensors 26 which establish a safety range for the vehicle and monitoring using sensing 26a, e.g., ultrasound sound waves, as represented in FIG. 4. The safety range is a specified area around the vehicle, for example six feet, such that any object entering the six foot area around the vehicle triggers the proximity sensors 26 to communicate the danger of contact with the object to the driver via the processor 46, e.g., a sound, or a light or both, and/or a cell phone call. In the event that the safety range is breached, the processor 46 initiates the camera 28 and begins recording. An alert is sent to, for example, the driver's cell phone and/or an override to the vehicles sound system alerting the occupants of a potential impact. If no impact is sensed by the motion sensor, the processor stops the audio alert and the camera 28, and the data processed by the processor 46 is deleted.

In the event that an impact is sensed, the processor 46 sends a communication using the transceiver 32 to generate a call via the driver's cell phone to communicate 38 with a support resource center receiving device 58. The data sent to the support center includes the location of the event, recorded data from the cameras 28 prior and post impact using transmission features included in the cell phone. Alternatively, the transceiver 32 may send a communication signal and data directly to the receiving device 58 at a resource center. The transceiver 32 may include a location device such as a GPS device, and thereby transmit the location of the vehicle 50 and image data to a receiving device 58 without using the driver's 54 cell phone.

Referring to FIG. 5, an embodiment of the method 100 according to the present invention includes a first step 104 of activating the device 20. The device 20 may also be deactivated 108 by the user because, for example, the driver 54 arrived at their destination 110 and the system 10 or device 20 is no longer needed. When the driver deactivates the device 20, the device 20 and the mounting equipment (not shown) may be removed from the car roof and stored, for example, in the vehicle 50.

When the user does not deactivate the device, the processor 46 of the device 20 performs a self check 114 which includes, for example, checks on the motions sensors 24, and proximity sensors 26. If the processor 46 determines that all systems are functional 118a the proximity sensors 26 and motion sensors 24 begin scanning 122. If the processor determines that all the systems are not functional 118b the method proceeds by sending a repair alert to the user 126 wherein the user receives the alert 130 and can take action. For example, the user may ensure that all connections are correctly connected, and that no obstacles are blocking the sensors. If no correction to the problem is apparent, the device 20 can be subject to maintenance.

Once the system is initiated and the systems are functional, the motion sensors 24 and the proximity sensors 26 monitor for potential events 134. When an event is detected 138, three options are available 142a, 142b, 142c which may be implemented simultaneously. The processor 46 sends an alert to the driver via the driver's cellular phone and overrides the radio 138a. The alert overrides the AM/FM radio, CODs or cassette tapes or DVDs that are playing. The processor 46 may also override a cell phone call in progress. For example, a hands free cellular call in progress can be overridden to report the alert. In this embodiment, a cell phone wireless feature supports simultaneously handling of both data and voice transmissions and multiple calls (e.g., call waiting), which enables the cell phone to handle the incoming alert as an interrupt. If the user is currently on the phone, the current caller is put into call waiting, the emergency number is dialed, and the images are transferred. Alternatively, the alert can break into the current call and announce a problem so the other party knows why the line was put on call waiting, then the call is interrupted and the photographs/emergency call is transmitted.

Thus, the alert is communicated to the user by overriding the cell phone and/or the audio system. Further, the device 20 thus enables notification of potential events that are outside of the normal visual range of the driver, such as side and/or rear impacts or potential impacts.

Additionally, the cameras 28 begin recording 138c from all four sides of the device 20 through the transparent lens protectors 30 (only two shown in FIG. 1) using the cameras 28 (only one shown in FIG. 2). The recording can be stored on local storage in the processor, as well as, in the cell device 140 or, in a separate memory module, e.g., a flash card 141. Redundantly storing the camera images is advantageous as copies may be needed for post accident reports. The automatic recording of the vehicular event may also be advantageous for recording data from other vehicle(s) involved in an accident, such as, make and/or model of another car, or a license plates number(s).

If an impact is detected, the processor 46 sends an alert 142a that the emergency process has begun and activates the cell phone location tracking feature. Once the data is known, the information is prepared for sending. The user also receives a message 146 that the emergency process has begun. Further, the stored digital camera images from step 140 is sent in step 150 by the wireless (cell) phone along with the driver's location and recorded data from step 142b. According to step 154, a receiving device 58 at a service providers support center receives the data. The data is then reviewed 158 to access the dispatch of help as required, e.g., emergency personnel. A service provider agent can review the data, attempt to contact the vehicle to make voice connection to determine other needs. The agent can also dispatch calls to local authorities or emergency crews, such as, police, firefighters, or medical personnel. The agent can continue to address the emergency until support resources, as an example, relieve the agent. The agent can save the data and make it available for later use by the customer, insurance company, or law enforcement. Additionally, the user can override the process at step 162 after receiving notice via their cell phone that the emergency process has begun 146. The use can override the process by sending a command from their cell phone to the processor 46.

The processor also determines if an impact is detected 138b using the motion sensors 24. If no impact is detected, the processor resets 142 the motion sensor 24 the proximity sensor 26 and the recording device 26, and erases any stored recording to prepare for the next event. Thus, the reset 142 is completed and the system returns to monitoring for a potential event 134.

The device and system of monitoring a vehicular event is advantageous, for example, because the device is portable and can be moved between vehicles. Further, the device 20 provides a technical service solution for rapid accident notification.

While the present invention has been particularly shown and described with respect to preferred embodiments thereof, it will be understood by those skilled in the art that changes in forms and details may be made without departing from the spirit and scope of the present application. It is therefore intended that the present invention not be limited to the exact forms and details described and illustrated herein, but falls within the scope of the appended claims.

What is claimed is:

1. A portable communication device for use with a vehicle, comprising:
a housing defining an inside cavity;
a monitoring device being located in the inside cavity of the portable communication device for initiating a signal upon the occurrence of a vehicular event; and
a transmitting device housed in the inside cavity for transmitting the signal to a remote receiving device to communicate the vehicular event.

2. The device of claim 1, wherein the vehicular event includes an impact to the vehicle.

3. The device of claim 1, wherein a image recording device records the vehicular event.

4. The device of claim 1, wherein the vehicular event includes an impact to the vehicle and an image recording device records the event before impact and after impact.

5. The device of claim 1, wherein the monitoring device includes a proximity sensor mounted inside the communication device to monitor the proximate surrounding of the vehicle, sense impending contact between the vehicle and an object, and initiate an alarm to the driver and initiate an image recording device when the proximity sensor detects the impending contact.

6. The device of claim 1, wherein the monitoring device includes a proximity sensor mounted in the inside cavity of the housing to monitor the proximate surroundings of the vehicle, and sense impending contact between the vehicle and an object, and initiate an alarm to the driver and initiate a image recording device when the proximity sensor detects the impending contact, and the image recording device records the impending contact, contact, and post contact for a specified period of time and automatically sends the recording to a remote location.

7. The device of claim 1, further including a transceiver for receiving a signal from the monitoring device and transmitting a signal to a receiving device to alert the driver.

8. The device of claim 1, further including a transceiver for receiving a signal from the monitoring device and transmitting a signal to a first receiving device to alert the driver and/or a second receiving device to alert response personnel.

9. The device of claim 1, wherein the housing is mounted to a vehicle.

10. A portable communication system for use with a vehicle, comprising:
a portable communication device defining an inside cavity;
a monitoring device being housed in the inside cavity of the portable communication device for initiating a signal upon the occurrence of a vehicular event;
a transmitting device housed in the inside cavity for transmitting the signal; and
a remote receiving device for receiving the signal to communicate the vehicular event to a driver.

11. The system of claim 10, wherein the signal is a first signal and the remote receiving device is a first remote receiving device and further including a second signal transmitted by the transmitting device and a second remote receiving device for communicating the vehicular event to response personnel.

12. A method of communicating a vehicular event, comprising:
monitoring a vehicle for a specified vehicular event;
initiating a signal upon the occurrence of the specified event; and
receiving the signal at a remote location to communicate the vehicular event to a response unit.
